(19) United States
(12) Patent Application Publication
(10) Pub. No.: US 2014/0004382 A1
(43) Pub. Date: Jan. 2, 2014

(54) CORROSION-RESISTANT BRICK AND METHOD FOR MANUFACTURING SAME

(71) Applicant: MITSUBISHI MATERIALS CORPORATION, Tokyo (JP)

(72) Inventors: Kenichi Yamaguchi, Iwaki-shi (JP); Yusuke Kimura, Iwaki-shi (JP)

(21) Appl. No.: 13/926,210

(22) Filed: Jun. 25, 2013

(30) Foreign Application Priority Data
Jun. 29, 2012 (JP) 2012-147246

(51) Int. Cl. F27D 1/00; F27D 1/16

(52) U.S. Cl. CPC F27D 1/0006; F27D 1/1684
USPC 428/693.1; 427/130

(57) ABSTRACT

The corrosion-resistant brick is a corrosion-resistant brick obtained by, in an Al—Cr-based brick, an Al—Mg-based brick and a Cr—Mg-based brick, providing a layer of magnetite powder on a brick surface, and heating and melting the magnetite powder so as to react the respective components of the brick with Fe, thereby forming a coating layer which is a ternary oxide of the brick components and Fe, and is made of a spinel solid solution having a melting point of 1600° C. or higher.

Priority is claimed on Japanese Patent Application No. 2012-147246, filed on Jun. 29, 2012, the content of which is incorporated herein by reference.

### BACKGROUND OF THE INVENTION

1. Field of the Invention

The present invention relates to a corrosion-resistant brick with a long service life, which is a brick used in, for example, a non-ferrous smelting furnace, an e-waste recycling melting furnace and the like, and has excellent corrosion resistance with respect to erosion by a melt, and a method for manufacturing the same.

2. Description of Related Art

Magnesia-chromia bricks (hereinafter, written as Cr—Mg-based bricks), magnesia-alumina bricks (hereinafter, written as Al—Mg-based bricks), alumina-chromia bricks (hereinafter, written as Al—Cr-based bricks), and the like are used in a non-ferrous smelting furnace, an e-waste recycling melting furnace and the like. Except for electrocast bricks, these bricks have a large porosity of 2% to 40%. Generally, since bricks are brought into contact with a melt in a furnace, and subject to chemical erosion in which the chemical components of the melt are incorporated into the grain boundaries in the bricks, the degree of the chemical erosion is high in bricks with a large porosity. For example, SiO₂, FeO, CaO, Na₂O and the like, which are the components of a melt such as slag, penetrate into the grain boundaries in bricks, and react with MgO, Cr₂O₃, Al₂O₃ and the like, which are the components of the bricks, whereby the chemical erosion proceeds.

In order to prevent the chemical erosion, measures that change the compositions of bricks, the states of constituent particles or manufacturing methods have been performed. For example, regarding alumina-magnesia bricks, a magnesia spinel refractory is known in which periclase with magnesia crystals has closed pores with a pore diameter of 1 μm to 5 mm, the periclase has a similar size, and the crystal grain boundaries in the periclase are composed of spinel phases including the periclase and MgO—Al₂O₃ (refer to Japanese Unexamined Patent Application, First Publication No. 2000-281429).

### SUMMARY OF THE INVENTION

### Problems to be Solved by the Invention

The invention provides a brick in which chemical erosion caused by a reaction between brick components and the components of a melt such as slag, particularly, the erosion of slag components into grain boundaries in the brick is inhibited by forming a coating layer with specific components on a brick surface instead of using a method for adjusting the constituents of a brick, thereby enhancing corrosion resistance.

### Means to Solve the Problems

The invention relates to a corrosion-resistant brick includes the following configuration.

[1] A corrosion-resistant brick includes a main body and a coating layer formed on a surface of the main body, wherein the main body is any one of an Al—Cr-based brick, an Al—Mg-based brick and a Cr—Mg-based brick, the coating layer is a ternary oxide of Fe and each component of the Al—Cr-based brick, the Al—Mg-based brick or the Cr—Mg-based brick, and the coating layer is made of a spinel solid solution having a melting point of 1600° C. or higher.

[2] The corrosion-resistant brick according to the above [1], wherein the coating layer is the spinel solid solution having a melting point of 1600° C. or higher which is a ternary oxide obtained by, during manufacturing of the brick, providing a layer of magnetite powder on a brick surface to be fired, heating and melting the magnetite powder, and reacting the magnetite powder with the components of the brick.

[3] The corrosion-resistant brick according to the above [1] or [2], wherein the coating layer is an Al—Cr—Fe oxide solid solution, an Al—Mg—Fe oxide solid solution or a Cr—Mg—Fe oxide solid solution, and is the spinel solid solution having a melting point of 1600° C. or higher.

In addition, the invention relates to a method for manufacturing a corrosion-resistant brick includes the following configuration.

[4] A method for manufacturing a corrosion-resistant brick includes a step of providing a layer of magnetite powder on a surface of a brick to be fired, during manufacturing of the brick, the brick include any one of an Al—Cr-based brick, an Al—Mg-based brick and a Cr—Mg-based brick, a step of heating and melting the magnetite powder, so as to react Fe and components of Al—Cr-based brick, an Al—Mg-based brick or a Cr—Mg-based brick and a step of forming a coating layer on a surface of a main body in the corrosion-resistant brick, wherein the coating layer is formed of a ternary oxide of Fe and the components of the brick, and is made of a spinel solid solution having a melting point of 1600° C. or higher.

[5] The method for manufacturing a corrosion-resistant brick according to the above [4], wherein a brick to be fired having the layer of magnetite powder formed on the surface is heated to a melting point of magnetite or higher in an inert atmosphere so as to melt the magnetite powder, then, the atmosphere is switched to an air atmosphere, the brick is heated so as to react magnetite with the components of the brick, thereby forming a coating layer which is an Al—Cr—Fe oxide solid solution, an Al—Mg—Fe oxide solid solution or a Cr—Mg—Fe oxide solid solution, and is a spinel solid solution having a melting point of 1600° C. or higher, then, the atmosphere is switched to an inert atmosphere, and the brick is cooled to room temperature.

### Effect of the Invention

Since the corrosion-resistant brick of the present invention has the coating layer made of the spinel solid solution of the ternary oxide of the components of the brick and Fe on the brick surface, in a furnace, slag components cannot easily penetrate into the brick, and erosion caused by a reaction between the slag components and the brick components can be reliably suppressed. Therefore, the corrosion resistance of the brick significantly improves, and a brick with a long service life can be obtained.

### BRIEF DESCRIPTION OF THE DRAWINGS

FIG. 1 is a pattern diagram of an erosion test.

FIG. 2 is an EPMA photograph illustrating a cross-section of a contact portion between slag and pellets in the pellets of Example 1.

FIG. 3 is an enlarged view of a contact portion A between a spinel solid solution and the slag of FIG. 2.

FIG. 4 is an EPMA photograph illustrating a distribution state of Si obtained by a surface analysis in apart of FIG. 3.

FIG. 5 is an EPMA photograph illustrating a distribution state of Ca obtained by a surface analysis in the part of FIG. 3.

FIG. 6 is an EPMA photograph illustrating a cross-section of a contact portion between slag and pellets in the pellets of Comparative Examples.

FIG. 7 is an enlarged view of a contact portion B between pellets and slag of FIG. 6.

FIG. 8 is an EPMA photograph illustrating a distribution state of Si obtained by a surface analysis in a part of FIG. 7.

FIG. 9 is an EPMA photograph illustrating a distribution state of Ca obtained by a surface analysis in the part of FIG. 7.

### DETAILED DESCRIPTION OF THE INVENTION

Hereinafter, an embodiment for carrying out the invention will be described.

A corrosion-resistant brick of the embodiment is a corrosion-resistant brick of an Al—Cr-based brick, an Al—Mg-based brick or a Cr—Mg-based brick having a coating layer which is a ternary oxide of components of each of the bricks and Fe, and is made of a spinel solid solution having a melting point of 1600° C. or higher.

A corrosion-resistant brick of the embodiment, which formed by using an Al—Cr-based brick, an Al—Mg-based brick or a Cr—Mg-based brick, may include an Al—Cr-based brick (an Al—Cr-based brick portion), an Al—Mg-based brick (an Al—Mg-based brick portion) or a Cr—Mg-based brick (a Cr—Mg-based brick portion) as a main body and coating layer formed on a surface of the main body.

The general component amounts of the Al—Cr-based brick, the Al—Mg-based brick and the Cr—Mg-based brick are as follows.

Al—Cr-based brick: Al₂O₃ (50 mass % to 98 mass %)-Cr₂O₃ (2 mass % to 50 mass %)

Al—Mg-based brick: MgO (50 mass % to 98 mass %)-Al₂O₃ (2 mass % to 50 mass %)

Cr—Mg-based brick: MgO (40 mass % to 98 mass %)-Cr₂O₃ (2 mass % to 60 mass %)

The corrosion-resistant brick of the embodiment can be manufactured by, in the Al—Cr-based brick, the Al—Mg-based brick or the Cr—Mg-based brick, providing a layer of magnetite powder on a brick surface, heating and melting the magnetite powder, and reacting the each component of the bricks to be fired and Fe, during manufacturing of the brick, thereby forming a coating layer which is a ternary oxide of the brick components and Fe, and is made of a spinel solid solution having a melting point of 1600° C. or higher.

Examples of the magnetite powder that can be used a powder mixture having a magnetite (Fe₃O₄) composition obtained by mixing hematite powder (Fe₂O₃) and iron powder (Fe), magnetite powder (Fe₃O₄), magnetic iron oxide powder and the like.

Specifically, the coating layer made of the spinel solid solution can be formed on the brick surface using, for example, the following method.

(i) During the manufacturing of the brick, magnetite powder (Fe₃O₄ powder) is dispersed on the surface of the Al—Cr-based brick, the Al—Mg-based brick or the Cr—Mg-based brick, which are yet to be fired, thereby forming a magnetite powder layer on the surface of the brick.

(ii) The brick to be fired is placed in a firing furnace so that the magnetite powder layer is upward, an inert atmosphere (argon, nitrogen, helium or the like) is formed in the furnace, and the brick is heated to the melting point of magnetite or higher, thereby melting the magnetite powder.

(iii) Next, the atmosphere is switched to an air atmosphere, and the brick is further heated to approximately 1650° C. Molten magnetite is incorporated into grain boundaries in the brick from the brick surface, and reacts with the each of component [magnesia (MgO), chromia (Cr₂O₃) and alumina (Al₂O₃)] that form the structure of the brick, thereby forming a dense spinel solid solution.

The heating temperature in the firing furnace when the inert atmosphere is kept in the firing furnace is preferably 1550° C. to 1600° C. On the other hand, the heating temperature in the firing furnace when the air atmosphere is kept in the firing furnace is preferably 1600° C. to 1700° C., and more preferably 1600° C. to 1650° C.

For example, the magnetite that has been incorporated into the grain boundaries in the brick reacts with the components of the Al—Cr-based brick so as to form an Al₂O₃—Cr₂O₃—Fe₃O₄ spinel solid solution. In addition, the magnetite reacts with the components of the Al—Mg-based brick so as to form an Al₂O₃—MgO—Fe₃O₄ spinel solid solution. In addition, the magnetite reacts with the components of the Cr—Mg-based brick so as to form a Cr₂O₃—MgO—Fe₃O₄ spinel solid solution.

The solid solutions formed of a ternary oxide of the components of the brick and Fe (Al₂O₃—Cr₂O₃—Fe₃O₄ spinel solid solution, Al₂O₃—MgO—Fe₃O₄ spinel solid solution and Cr₂O₃—MgO—Fe₃O₄ spinel solid solution) have different melting points according to the amount of Al₂O₃, Cr₂O₃, Fe₃O₄ and MgO. Therefore, the spinel solid solution which is formed of the ternary oxide of the components of each brick and Fe and has a melting point of 1600° C. or higher is formed by adjusting the amount of magnetite and the heating conditions according to the amount of the respective brick components.

The temperature of molten slag of a non-ferrous metal, such as lead or copper, which is brought into contact with the bricks in the furnace is generally 1000° C. to 1300° C. Additionally, the melting points of the ternary spinel solid solutions (Al₂O₃—Cr₂O₃—Fe₃O₄ spinel solid solution, Al₂O₃—MgO—Fe₃O₄ spinel solid solution and Cr₂O₃—MgO—Fe₃O₄ spinel solid solution) are all 1600° C. or higher. Therefore, when the coating layer made of the spinel solid solution is brought into contact with the molten slag, the spinel solid solution is not melted and is not peeled off from the brick surface due to a mechanical pressure of the molten slag.

Since the spinel solid solution formed of the ternary oxide of the brick components and Fe is a dense solid solution having a spinel structure, when the spinel solid solution is formed on the surface of the brick, it is possible to reliably prevent the slag components (SiO₂, FeO, CaO, Na₂O and the like) from penetrating into the grain boundaries in the brick and to sufficiently suppress the dissolution of the brick components (MgO, Cr₂O₃, Al₂O₃ and the like).

The thickness of the coating layer made of the spinel solid solution formed on the brick surface may be preferably in a range of 0.5 mm to 100 mm (approximately 0.1% to 25% of a brick thickness) from the brick surface, and more preferably in a range of 20 min to 60 mm (approximately 5% to 15% of the brick thickness) from the brick surface.

### EXAMPLES

Examples of the invention will be described below together with Comparative Examples.

In Examples and Comparative Examples, the cross-sectional photographs of pellets and slag are EPMA photographs, and BEI in the photographs is the abbreviation for BACKSCATTERED ELECTRON IMAGE. In a surface analysis of elements using an EPMA, a larger white portion in the distribution of Si or Ca in the photograph indicates the distribution of a larger amount of the corresponding element. Element-free portions look black.

### Example 1

### Al—Cr-Based Brick

Corrosion-resistant Al—Cr-based brick pellets 1 having a coating layer made of an Al₂O₃—Cr₂O₃—Fe₃O₄ spinel solid solution on surfaces were manufactured in the following order.

(i) Alumina powder (Al₂O₃) and chromia powder (Cr₂O₃) were mixed at a weight ratio of 65:35, the powder mixture (1.3 g) was charged into a mold (diameter: 12 mm), and pressed at a pressure of approximately 3 T/cm², thereby obtaining the pellets 1 (Al₂O₃—Cr₂O₃ brick specimen).

(ii) Approximately 1 cm-width paper was wound on a side surface of the pellet 1, and a top portion of the paper was projected from a pellet top end surface so as to surround the pellet top end surface.

(iii) Additionally, hematite powder (Fe₂O₃) and iron powder (Fe) were mixed so as to prepare a powder mixture with a magnetite (Fe₃O₄) composition.

(iv) The powder mixture (0.13 g) with a magnetite (Fe₃O₄) composition was evenly dispersed and deposited on the top end surfaces of the pellets 1 surrounded with the paper.

(v) The pellets 1 having the powder mixture with a magnetite composition dispersed on the top end surface were put into a magnesia crucible, charged into an electric furnace, initially heated to 1550° C. in an argon gas stream, the powder mixture with a magnetite (Fe₃O₄) composition was melted, then, the stream was switched to an air stream, the pellets were heated to 1650° C., and held for approximately 1 hour. After that, the heating was stopped, the stream was switched to an argon gas stream again, the pellets were cooled to room temperature, and removed from the electric furnace.

### Example 2

### Al—Mg-based Brick

(i) Magnesia powder (MgO) and alumina powder (Al₂O₃) were mixed at a weight ratio of 85:15, the powder mixture (1.3 g) was charged into a mold (diameter: 12 mm), and pressed at a pressure of approximately 3 T/cm², thereby obtaining the pellets 2 (MgO—Al₂O₃ brick specimen).

Then, the treatments (ii) to (v) were carried out in the same manner as in Example 1, thereby manufacturing corrosion-resistant Al—Mg-based brick pellets 2 having a coating layer made of an Al₂O₃—MgO—Fe₃O₄ spinel solid solution on surfaces.

### Example 3

### Mg—Cr-Based Brick

(i) Magnesia powder (MgO) and chromic powder (Cr₂O₃) were mixed at a weight ratio of 80:20, the powder mixture (1.3 g) was charged into a mold (diameter: 12 mm), and pressed at a pressure of approximately 3 T/cm², thereby obtaining the pellets 3 (MgO—Cr₂O₃ brick specimen).

Then, the treatments (ii) to (v) were carried out in the same manner as in Example 1, thereby manufacturing corrosion-resistant Mg—Cr-based brick pellets 3 having a coating layer made of a MgO—Cr₂O₃—Fe₃O₄ spinel solid solution on surfaces.

The brick pellets 1 to 3 all had traces of black magnetite, which had been melted and impregnated into the pellets, remaining on the surfaces on which magnetite had been dispersed and deposited, and it could be confirmed that, when the brick pellets were brought close to a magnet, the brick pellets were adsorbed such that magnetite was melted and intruded into the pellets.

### Comparative Examples

In Example 1, the treatments (ii) to (v) were not carried out after pellets were manufactured using the above (i), and, instead, the pellets were fired at 1650° C. for 1 hour, thereby manufacturing Al—Cr-based brick pellets B1 having no coating layer, which were used as a comparison specimen.

In Example 2, the treatments (ii) to (v) were not carried out after pellets were manufactured using the above (i), and, instead, the pellets were tired at 1650° C. for 1 hour, thereby manufacturing Al—Mg-based brick pellets B2 having no coating layer, which were used as a comparison specimen.

In Example 3, the treatments (ii) to (v) were not carried out after pellets were manufactured using the above (i), and, instead, the pellets were fired at 1650° C. for 1 hour, thereby manufacturing Mg—Cr-based brick pellets B3 having no coating layer, which were used as a comparison specimen.

[Erosion Test]

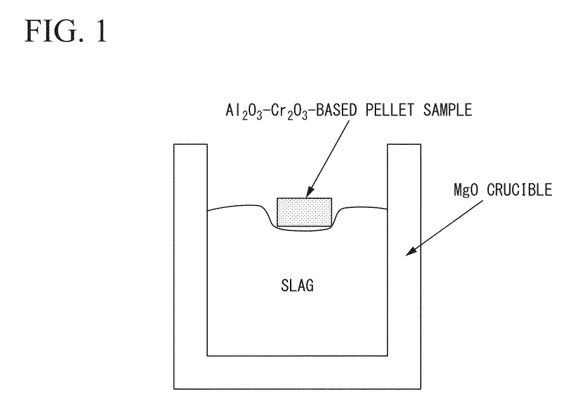

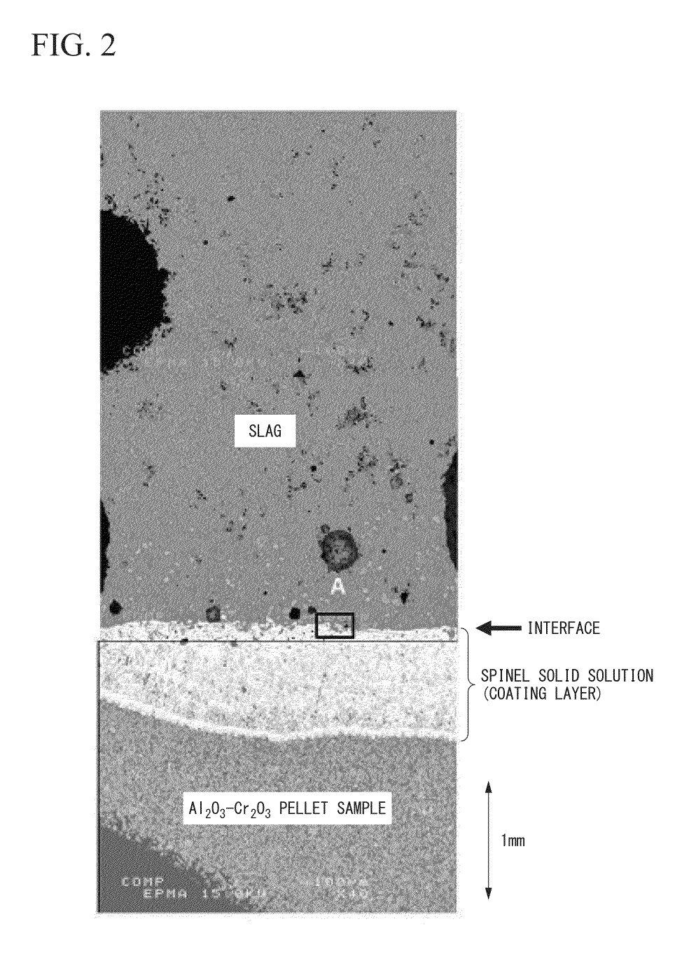

The corrosion-resistant brick pellets 1 to 3 prepared in Examples 1 to 3 were installed on the slag surfaces in magnesia crucibles so that the coating layers were brought into contact with slag as illustrated in FIG. 1, and held at 1300° C. for 24 hours in an argon gas atmosphere. As Comparative Examples, the surfaces of the brick pellets B1 to B3 having no coating layer were brought into contact with slag under the same conditions. After the holding time, the slag and the pellets were cut in each crucible, and the state of the contact portion between the slag and the pellets was observed. The composition of the slag is described in Table 1. The observed results are illustrated in FIGS. 2 to 9 and Table 2.

TABLE 1

| | Components | | | | | | |
|---|---|---|---|---|---|---|---|
| | SiO₂ | FeO | Al₂O₃ | CaO | MgO | Na₂O | Total |
| Composition (wt %) | 48 | 13 | 22 | 9 | 3 | 3 | 100 |

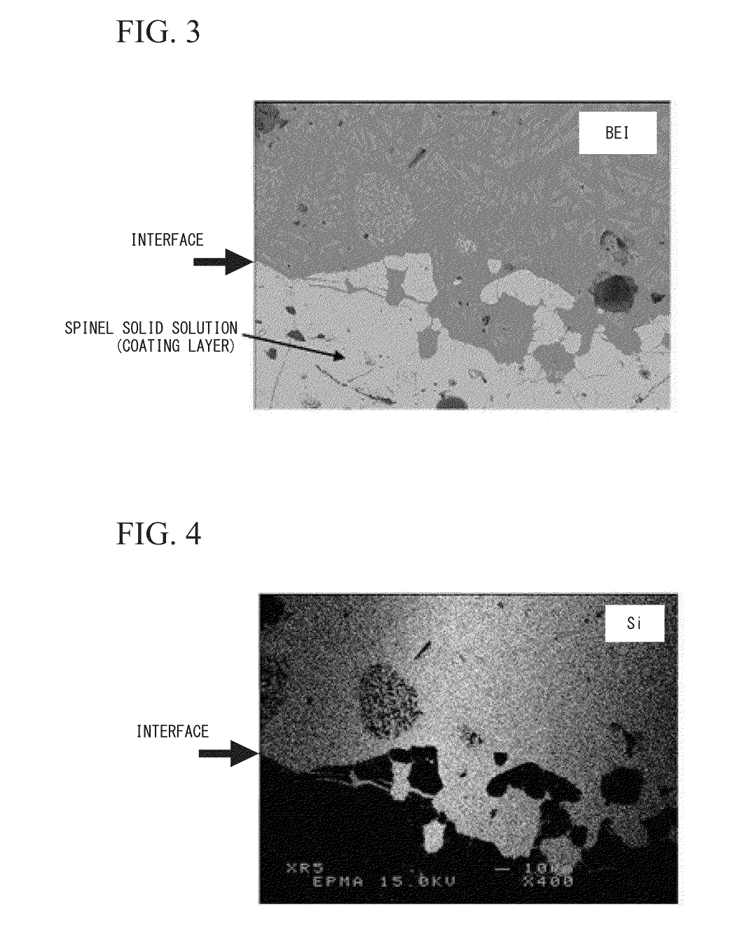

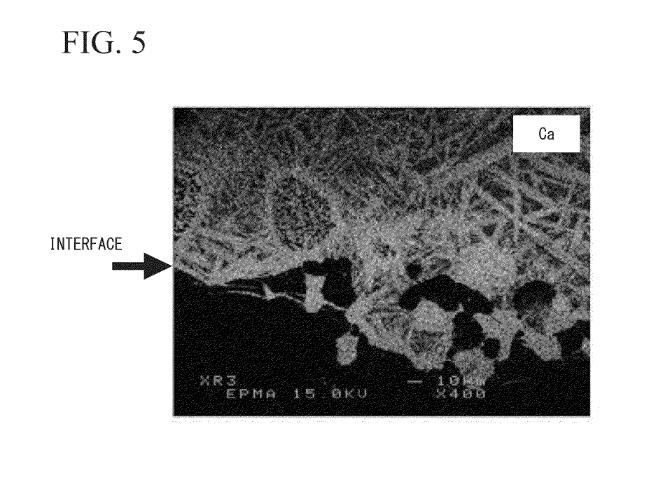

FIG. 2 illustrates the cross-section (EPMA photograph) of the contact portion between the slag and the pellet in the corrosion-resistant pellets 1 prepared in Example 1. FIG. 3 illustrates an enlarged view of a portion A that was brought into contact with the slag of the spinel solid solution in FIG. 2. In addition, FIG. 4 illustrates the distribution state of Si in the portion of FIG. 3 obtained using a surface analysis, and FIG. 5 illustrates the distribution state of Ca in the portion of FIG. 3 obtained using a surface analysis.

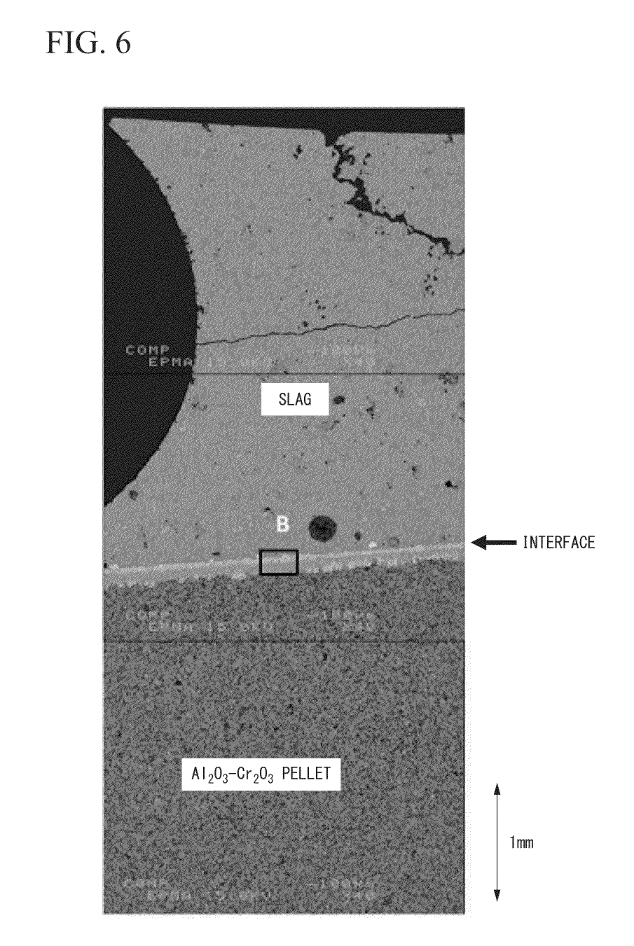

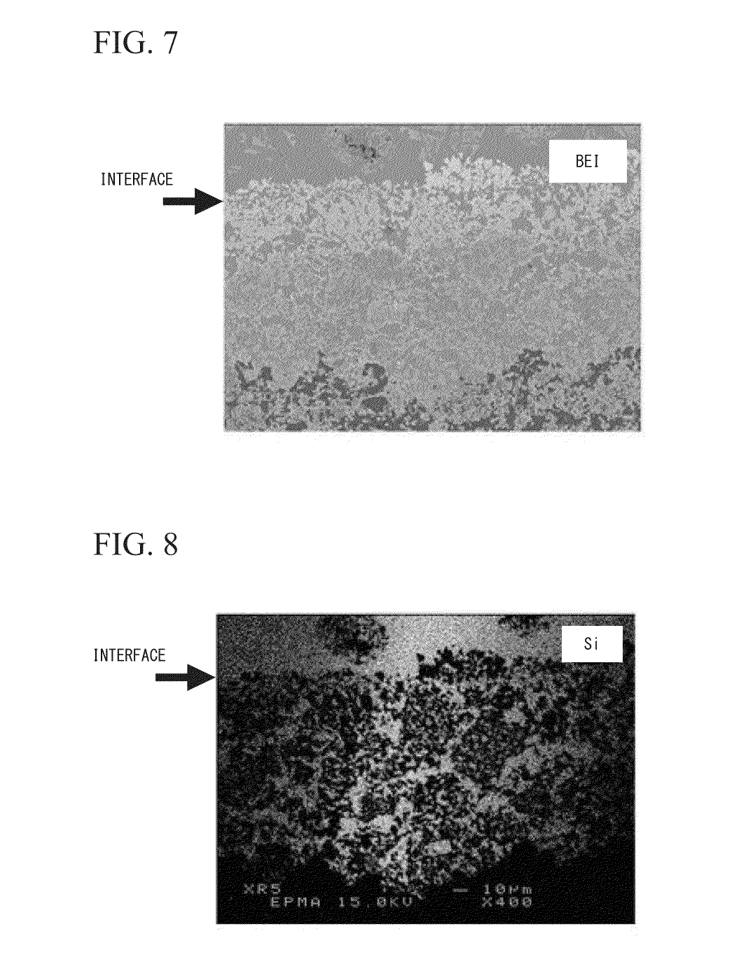

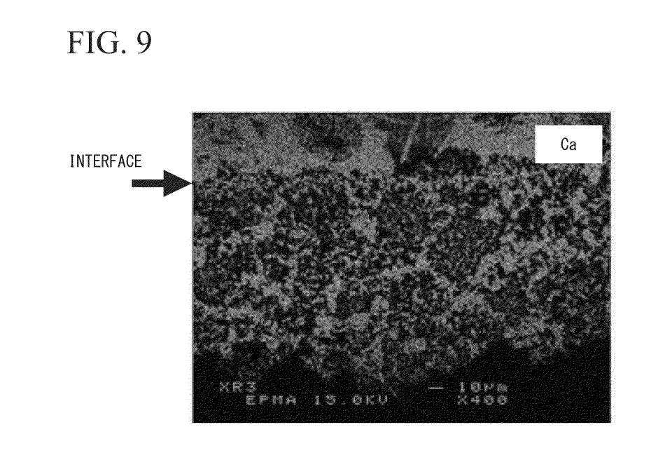

FIG. 6 illustrates the cross-section (EPMA photograph) of the contact portion between the slag and the pellet in the corrosion-resistant pellets B1 prepared in Comparative Example. FIG. 7 illustrates an enlarged view of a portion B that was brought into contact with the slag of the spinel solid solution in FIG. 6. In addition, FIG. 8 illustrates the distribution state of Si in the portion of FIG. 7 obtained using a surface analysis, and FIG. 9 illustrates the distribution state of Ca in the portion of FIG. 7 obtained using a surface analysis.

In the corrosion-resistant brick pellets 1 having the coating layer of the present invention, in the portion that was brought into contact with the slag of the spinel solid solution illustrated in FIG. 3, Si was not distributed in the area of the spinel solid solution as illustrated in FIG. 4, and Ca was not distributed in the area of the spinel solid solution either as illustrated in FIG. 5. The Si and Ca are the components of the slag, and thus it is found that the slag components do not penetrate into the area of the spinel solid solution. The same states were also observed for the corrosion-resistant pellets 2 and 3 of the invention. The observed results are described in Table 2.

On the other hand, in the pellets B1 of the comparison specimen having no coating layer, in the portion that was brought into contact with the slag of the spinel solid solution illustrated in FIG. 7, Si was incorporated into the area of the pellets as illustrated in FIG. 8, Ca was also incorporated into the area of the pellets as illustrated in FIG. 9, and the pellets were eroded by the slag components. The same states were also observed for the pellets B2 and B3 of the comparison specimens. The observed results are summarized and described in Table 2.

TABLE 2

| | | | Penetration |
|---|---|---|---|
| | Brick composition | Coating layer | state |
| Pellets 1 | Al (65 wt %)—Cr | Al₂O₃—Cr₂O₃—Fe₃O₄ | No |
| | (35 wt %) | | |
| Pellets 2 | Mg (85 wt %)—Al | Al₂O₃—MgO—Fe₃O₄ | No |
| | (15 wt %) | | |
| Pellets 3 | Mg (80 wt %)—Cr | MgO—Cr₂O₃—Fe₃O₄ | No |
| | (20 wt %) | | |
| Pellets B1 | Al (65 wt %)—Cr | None | Yes |
| | (35 wt %) | | |
| Pellets B2 | Mg (85 wt %)—Al | None | Yes |
| | (15 wt %) | | |
| Pellets B3 | Mg (80 wt %)—Cr | None | Yes |
| | (20 wt %) | | |

(Remarks)
Pellets 1 to 3 are Examples, and
Pellets B1 to B3 are comparison specimens.

The coating layer is a component of the spinel solid solution.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A corrosion-resistant brick comprising:
a main body and a coating layer formed on a surface of the main body, wherein
the main body is any one of an Al—Cr-based brick, an Al—Mg-based brick and a Cr—Mg-based brick,
the coating layer is a ternary oxide of Fe and each component of the Al—Cr-based brick, the Al—Mg-based brick or the Cr—Mg-based brick, and
the coating layer is made of a spinel solid solution having a melting point of 1600° C. or higher.

2. The corrosion-resistant brick according to claim 1,
wherein the coating layer is the spinel solid solution having a melting point of 1600° C. or higher which is a ternary oxide obtained by, during manufacturing of the brick, providing a layer of magnetite powder on a brick surface to be fired, heating and melting the magnetite powder, and reacting the magnetite powder with the components of the brick.

3. The corrosion-resistant brick according to claim 1,
wherein the coating layer is an Al—Cr—Fe oxide solid solution, an Al—Mg—Fe oxide solid solution or a Cr—Mg—Fe oxide solid solution, and is the spinel solid solution having a melting point of 1600° C. or higher.

4. A method for manufacturing a corrosion-resistant brick comprising:
a step of providing a layer of magnetite powder on a surface of a brick to be fired, during manufacturing of the brick, the brick include any one of an Al—Cr-based brick, an Al—Mg-based brick and a Cr—Mg-based brick;
a step of heating and melting the magnetite powder, so as to react Fe and components of Al—Cr-based brick, an Al—Mg-based brick or a Cr—Mg-based brick; and
a step of forming a coating layer on a surface on a main body in the corrosion-resistant brick,
wherein the coating layer is formed of a ternary oxide of Fe and the components of the brick, and is made of a spinel solid solution having a melting point of 1600° C. or higher.

5. A method for manufacturing a corrosion-resistant brick comprising:
a step of providing a layer of magnetite powder on a brick surface to be fired, in an Al—Cr-based brick, an Al—Mg-based brick or a Cr—Mg-based brick, during manufacturing of the brick,
a step of heating and melting the magnetite powder, so as to react components of the brick and Fe, and
a step of forming a coating layer which is formed of a ternary oxide of the components of the brick and Fe, and is made of a spinel solid solution having a melting point of 1600° C. or higher.

6. A method for manufacturing a corrosion-resistant brick according to claim 5,
wherein a brick to be fired having the layer of magnetite powder formed on the surface is heated to a melting point of magnetite or higher in an inert atmosphere so as to melt the magnetite powder,
then, the atmosphere is switched to an air atmosphere, and the brick is heated so as to react magnetite and the components of the brick, thereby forming a coating layer which is an Al—Cr—Fe oxide solid solution, an Al—Mg—Fe oxide solid solution or a Cr—Mg—Fe oxide solid solution, and is a spinel solid solution having a melting point of 1600° C. or higher,
then, the atmosphere is switched to an inert atmosphere, and the brick is cooled to room temperature.
